(19) United States
(12) Patent Application Publication
(10) Pub. No.: US 2011/0179012 A1
(43) Pub. Date: Jul. 21, 2011

(54) NETWORK-ORIENTED INFORMATION SEARCH SYSTEM AND METHOD

(75) Inventor: Paul Pedersen, Palo Alto, CA (US)

(73) Assignee: Factery.net, Inc., Menlo Park, CA (US)

(21) Appl. No.: 13/007,179

(22) Filed: Jan. 14, 2011

Related U.S. Application Data
(60) Provisional application No. 61/295,532, filed on Jan. 15, 2010.

(51) Int. Cl. G06F 17/30

(52) U.S. Cl. 707/710; 707/E17.108

(57) ABSTRACT

A search system responds to a search query initially by identifying a set of network locators that are deemed relevant to the search query. The system then retrieves one or more information resources corresponding to each network locator. The system then processes the retrieved set of information resources to extract an information item from the set of information resources, and returns that information item to the user as a response to the search query. The returned information item may be in the form of a standard sentence in a language used for spoken and written communication among humans.

This application claims the benefit of U.S. Provisional Patent Application No. 61/295,532, filed on Jan. 15, 2010, which is incorporated herein by reference.

### FIELD OF THE INVENTION

At least one embodiment of the present invention pertains to network-oriented information search technology, and more particularly, to a technique for quickly providing relevant facts to a user in response to a search query on a network.

### BACKGROUND

Network-oriented information search technologies have undergone rapid maturation and improvements in recent years. These technologies are often quite effective for some purposes. Nonetheless, known search technologies still have certain shortcomings.

At least one well-known network search technology in use today continuously “crawls” the Internet to identify new or updated web pages and other types of information resources (e.g., video clips, audio files, photos, etc.). The search engine creates and continuously updates an index of these resources. In response to a search query from a user, the search engine processes the query against the index by using one or more search algorithms and produces a set of hyperlinks, i.e., uniform resource locators (URLs). These hyperlinks represent the information resources found by the search algorithm to be most relevant to the query; as such, the hyperlinks are provided to the user in response to the query. Sometimes each URL is shown along with a small amount of contextual information, such as a snippet of text that includes terms from the query as they appear within the referenced resource. The user then examines these URLs, along with any contextual information provided, and decides which of them, if any, are worth selecting (e.g., clicking on) to access and examine the corresponding resources.

A shortcoming of this search technology, however, is that it often provides too little information and requires too much effort from the user. Frequently the user is looking for the answer to a specific question or for a fairly specific piece of information, even though he may not know what that information looks like when he forms the query. With this known search technology, the user has to review the provided URLs and associated contextual information to determine which corresponding resources, if any, are worth actually retrieving. The user then has to click on them one at a time to access and examine each corresponding resource, and then determine the relevance of each resource and try to glean from it the information for which he was searching.

This process can involve a considerable amount of time and effort on the part of the user, depending on the nature of the search. Even with extremely effective search algorithms, the amount of time and effort required to actually obtain the sought-after information may be undesirable from the user's perspective. This is even more likely if the user is searching from a small-footprint mobile communication device, such as a smartphone or personal digital assistant (PDA), the relatively small user interfaces of which can make it difficult to navigate and examine effectively multiple levels of information.

Another type of known search technology is extensible markup language (XML) document query systems. These systems are specially designed for operating on XML markup language; as such, they are not well suited for identifying relevant information in standard human sentences, such as may be found in web pages, for example.

### SUMMARY

The technique introduced here includes a system and method for quickly providing relevant facts to a user of a search engine, directly in response to a search query. The technique eliminates the need for the user to review a list of links to determine which corresponding information resources, if any, are worth actually retrieving and to then click on them one at a time to review each corresponding information resource and to try to glean from them the sought-after information.

In certain embodiments, in response to a search query the system initially identifies a set of network locators, such as URLs, that are deemed relevant to the search query, including at least one network locator. This may involve invoking a set of third-party search application program interfaces (APIs). Each identified network locator corresponds to a separate information resource, such as a web page, stored on a network, such as the Internet. The system then retrieves the information resource (or resources) corresponding to each network locator so identified.

The system then processes the retrieved set of information resources to extract an information item from the set of information resources, and returns that information item to the user as a response to the search query. This returned information item is called a “fact” here and may be in the form of a standard sentence in a language used for spoken and written communication among humans, e.g., English, French, etc.

In certain embodiments, processing the set of information resources to extract the information item comprises: producing a normalized document for each information resource in the retrieved set of information resources, producing a “gobbet” set, including at least one gobbet, from each such normalized document; selecting at least one gobbet from the gobbet set; and creating the above-mentioned information item for output to the user, from the selected at least one gobbet.

A “gobbet”, as the term is used here, is a fragment of information extracted from its original source and context. In certain embodiments a separate gobbet is generated for each paragraph and for each individual sentence in each normalized document generated from the retrieved information resources. A gobbet can be represented as a data object in the system, which can include a gobbet identifier, a network locator corresponding to a source of the gobbet, and various content items, including a subject phrase and a verb phrase.

In certain embodiments, processing the set of information resources to extract the information item further comprises storing and indexing, in a gobbet repository, each gobbet in the gobbet set produced from the query. It may include querying the gobbet repository with the user query to retrieve a result gobbet set including at least one gobbet, then forming a fact from the result gobbet set, and then returning the fact as a response to the user's search query, for output to the user.

Other aspects of the technique will be apparent from the accompanying figures and from the detailed description which follows.

### BRIEF DESCRIPTION OF THE DRAWINGS

One or more embodiments of the present invention are illustrated by way of example and not limitation in the figures of the accompanying drawings, in which like references indicate similar elements and in which:

FIG. 1 illustrates a network environment including a search system;

FIG. 2 illustrates an example of the internal elements of the search system;

FIG. 3 is a flow diagram illustrating an example of the overall process performed by the search system to respond to a user's search query;

FIG. 4 shows an example of a portion of a web page;

FIGS. 5A through 5E show excerpts from source code associated with the portion of the web page shown in FIG. 4;

FIG. 6 illustrates an example of a portion of a normalized document corresponding to the portion of the source code illustrated in FIGS. 5A through 5E;

FIG. 7 is a flow diagram illustrating an example of the operation of the sentence processor, for a given normalized document as input;

FIG. 8A illustrates a verb phrase repository partitioned into multiple tiers;

FIG. 8B illustrates an example of using a sliding n-gram in the process of identifying verb phrases in the sentence;

FIG. 9 illustrates an example of a gobbet;

FIG. 10 is a flow diagram illustrating an example of the process of querying the gobbet repository with a user query to retrieve a term set;

FIG. 11 is a flow diagram illustrating an example of the process of generating a fact set from a term set; and

FIG. 12 is a block diagram of the architecture of a processing system that can embody the search system and/or a client system.

### DETAILED DESCRIPTION

To facilitate description, the technique introduced here is generally described here by using URLs as examples of network locators, web pages as examples of information resources, and the Internet as an example of the target information base to be searched. However, various embodiments of the technique introduced here may alternatively (or additionally) handle other types of network locators, information resources and/or target information bases.

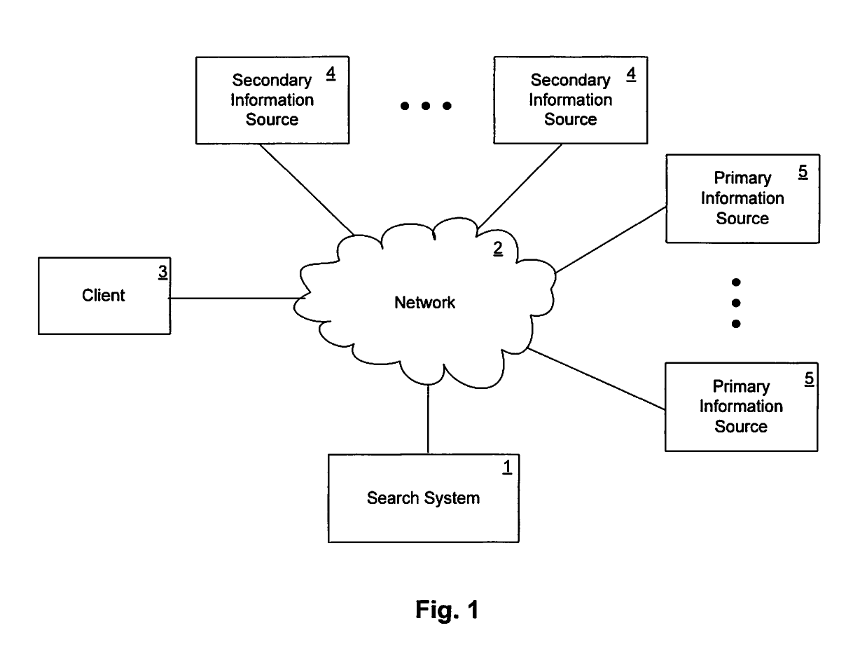

FIG. 1 illustrates a network environment in which the search system and method introduced here can be implemented. A search system 1 in accordance with the techniques introduced here is coupled to a network 2, such as the Internet. The search system 1 can be or include one or more conventional server-class computers, for example. Also coupled to the network 2 are one or more client systems 3, which may be of different types. Each client system 3 can be, for example, a conventional personal computer (PC), a server-class computer, a handheld communication/computing device (e.g., smartphone or PDA), etc. Note that while a client system 3 and search system 1 are described herein as separate entities on the network, in other embodiments a client system 3 and the search system 1 may be contained within a single computer or other self-contained physical platform.

A user (not shown) of a client system 3 forms a search query, which is transmitted by the client system 3 to the search system 1 via the network 2 using any known or convenient protocol(s), such as hypertext transfer protocol (HTTP). The search query can be in the form of, for example, a conventional keyword search of the type used with conventional search engines known today, such as Google, Yahoo, etc. The search query can be, but is not necessarily, in the form of a natural language search.

In one embodiment, in response to the user's search query, the search system initially identifies a set of URLs that are deemed relevant to the search query, including at least one network locator. This may involve generating and using a secondary query to invoke the published, well-known API of one or more secondary (third-party) information sources 4. The secondary information sources can include, for example, any one or more of: Twitter Recommender, Yahoo Boss, Google, Reuters, or any other information source that can provide a list of references (e.g., URLs) to information resources in response to a search query. Each such secondary information source 4 returns a set of one or more URLs in response to the secondary query. Note that the secondary query may be identical to the user query, or it may be a modified version of the user query (e.g., if necessitated by the particular API of any of the secondary information sources 4). Each URL returned to the search system 1 in response to the secondary query represents a separate information resource, such as a web page, stored on the network 2 at one or more primary information sources 5.

Still in response to the user's query, the search system 1 then retrieves the information resource (or resources) corresponding to each of the returned URLs. In some cases, the search system 1 may also access and retrieve additional information resources, such as those referenced by hyperlinks in the retrieved information resources, as explained below. The search system 1 then processes the retrieved set of information resources to extract from them one or more “facts” relevant to the users search query, and the extracted fact or facts are then returned to the client system 3 as a response to the user's query. A “fact” can be a standard sentence in a language used for spoken and written communication among humans, e.g., English, French, etc. The term “fact” is used here merely for convenience, since it connotes a complete yet concise unit of information; it does not imply anything about the truth or falsity of the information to which it pertains.

As an example of how the search system 1 operates, in response to the illustrative user search query, “highest city in the world”, the system 1 might return the following fact:
Topping the list as the highest city in the world is La Rinoconada in Peru. This city of 30,000 is known as the highest permanent human habitation and rightly so. Located in the Andes, La Rinoconada sits at 16,728 feet, more than 3100 feet above the next highest city, El Alto, Bolivia at 13,615 feet.
Gadling.com (as of Mar. 15, 2009).

The system 1 in this example has located a sentence identifying La Rinconada in Peru as the highest city in the world; it has computed the most useful enclosing context—in this case the next two sentences of the original article—and then attached a citation to the original source (the web site “gadling.com”), as well the most likely publication date (Mar. 15, 2009). The system 1 may also display, next to or after the result, a set of buttons that allow the user to provide feedback (e.g., a button to share on Facebook, a thumbs up icon to record a positive response, a thumbs down icon to record a negative response, and a star icon to record a “favoriting” response). The most likely publication date is determined by matching a by-line (in this example the article at gadling.com contains the by-line “by Kraig Becker (RSS feed) on Mar. 15, 2009 at 10:00AM”).

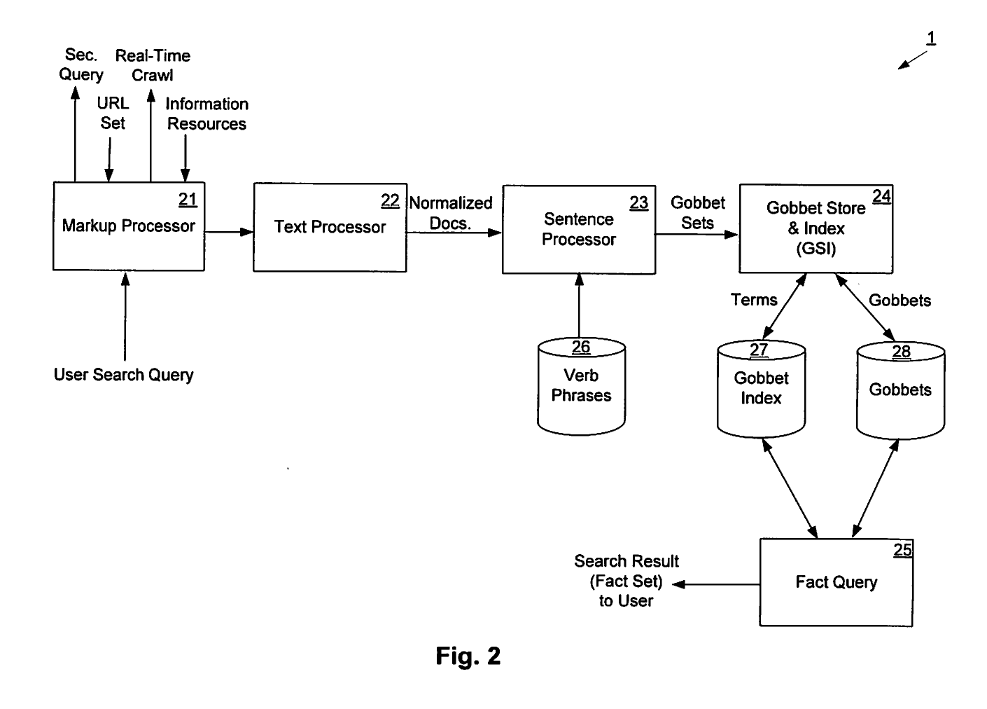

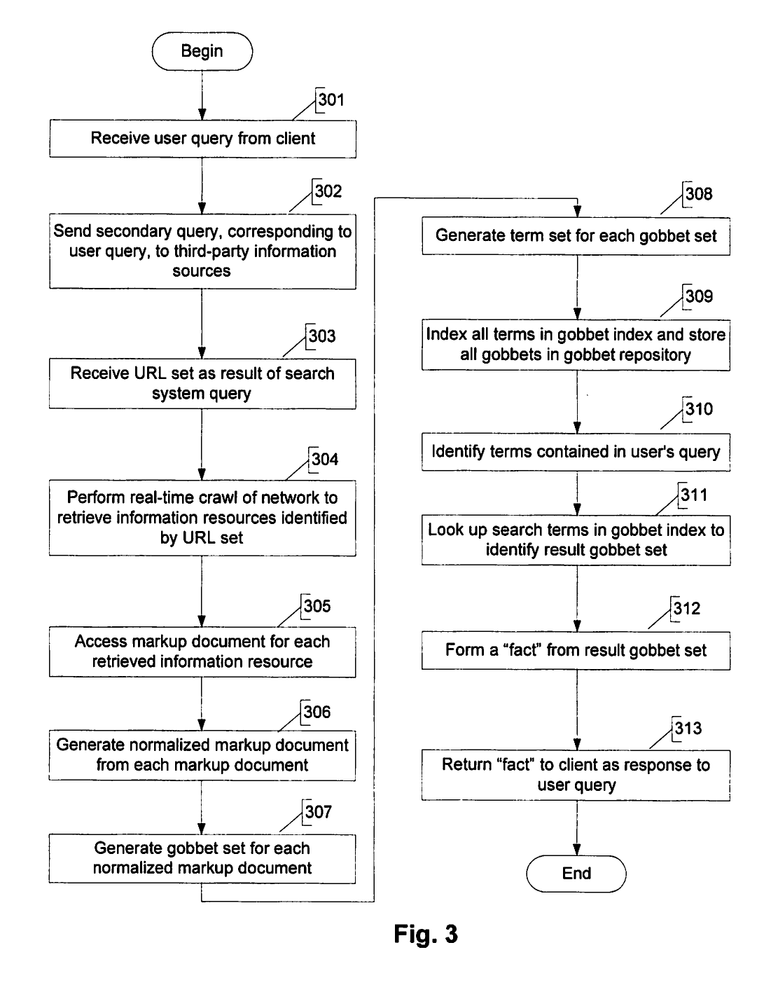

FIG. 2 illustrates an example of the internal elements of the search system. In the illustrated embodiment the search system 1 includes a markup processor 21, a text processor 22, a sentence processor 23, a gobbet store and index (GSI) module 24 and a fact query module 25. The functionality of these elements is described below in connection with FIG. 3. Each of these elements may be implemented by programmable circuitry programmed or configured by software and/or firmware, or entirely by special-purpose circuitry, or by a combination of such forms. Any such special-purpose circuitry can be in the form of, for example, one or more application-specific integrated circuits (ASICs), programmable logic devices (PLDs), field-programmable gate arrays (FPGAs), etc. In certain embodiments, some or all of these elements can be combined into a larger element that performs the function of each of them.

The search system 1 also includes a verb phrase repository 26, a gobbet repository 27 and a gobbet index 28. The gobbet repository 27 and gobbet index 28 (at least) also can be combined. Note that normally the functionality of all of the above mentioned elements is invoked in response to each user search query, as described below.

The markup processor 21 is the first stage of the search system 1 and has three main functions: First, it receives the user search query from a client system 3 (FIG. 3, 301) and, in response, it generates the secondary search query (302) and receives the resulting URL set (303) from the secondary information sources. Second, it performs a real-time crawl of the Internet to retrieve, from the secondary information sources 4, the information resources represented by the URL set (304). Third, the markup processor 21 accesses and outputs to the text processor 22 the source markup language document of each information resource retrieved by the real-time crawl. The markup language document can be in, for example, hypertext markup language (HTML) and, more specifically, it can be in the form of an HTML document object model (DOM).

In some instances, the markup processor 21 may also access and retrieve information resources that are “depth 2” or even deeper, i.e., web pages and/or other resources that are linked-to by the information resources retrieved in step 304. In one embodiment, the markup processor 21 will do so if the initial (depth 1) resource is a “hub” but not if it is an “authority” (as those terms are defined in the Hyperlink-Induced Topic Search (HITS) link analysis algorithm).

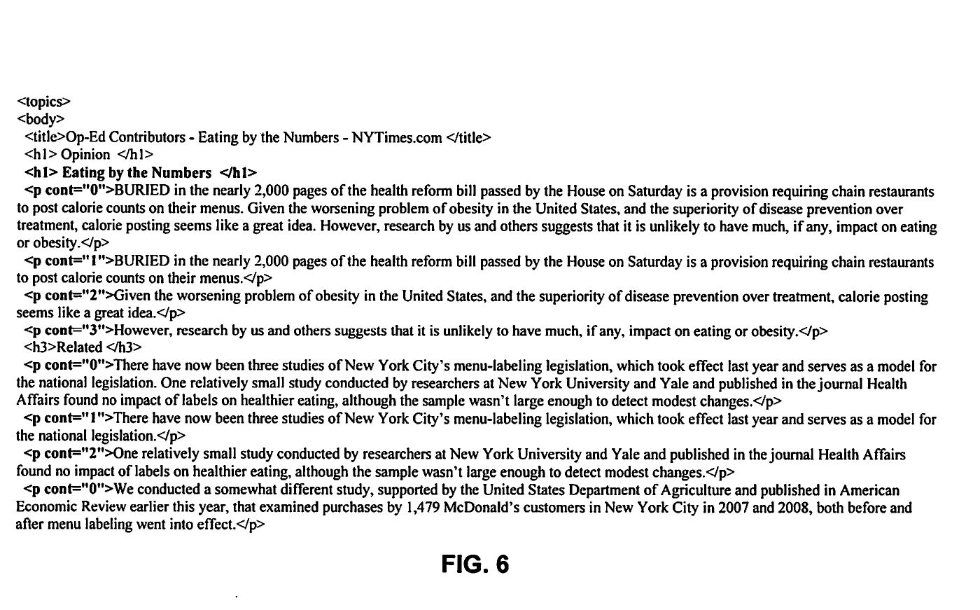

The text processor 22 receives each of the markup language documents from the markup processor 21 (305) and, for each one, performs a normalization process to produce a corresponding normalized markup language document (306). The normalization process generally puts each markup language document into a canonical format, which facilitates processing by subsequent stages of the search system 1. For example, the normalization process strips out information that is not needed, such as advertising, detailed page formatting information, and embedded scripts. Information that is retained includes, for example, the basic substantive content of the markup language document as well as all lists and key/value pairs (if any) in the markup language document, the most likely publication date, and relevant images and videos. In addition, the normalization process may also fix obvious spelling errors and/or address other formatting issues. An example of a normalized markup language document is described below and illustrated in FIGS. 6A and 6B.

The sentence processor 23 receives each normalized document from the text processor 22 and, for each normalized document, performs a linguistic analysis to generate and output a gobbet set (307), where each gobbet set contains one or more gobbets. A “gobbet”, as the term is used here, is a fragment of information extracted from its original source and context. In one embodiment each gobbet represents a single sentence or paragraph, and a gobbet set includes a separate gobbet for each paragraph and for each individual sentence in the corresponding normalized document. A gobbet that represents a sentence is called a “sentence gobbet” herein, and a gobbet that represents a paragraph is called a “paragraph gobbet” herein.

A gobbet can be represented as a data object in the search system 1, which can include a gobbet identifier, a network locator (e.g., a URL) corresponding to a source of the gobbet (e.g., a web page), and various content items, including, in the case of a sentence gobbet, a subject phrase, a verb phrase and an object phrase (if any) of the sentence that the gobbet represents. Further details and an example of a gobbet are described below.

The GSI module 24 indexes and stores, in the gobbet repository 27, each gobbet in each gobbet set that resulted from the user's query. More specifically, the GSI module 24 generates a set of terms found in each gobbet of each gobbet set (308), then indexes all of the terms and stores all of the gobbets in the gobbet repository 28 (309). Each term is stored and indexed in the gobbet index 27 so that the gobbet or gobbets in which it appears can be quickly and easily identified. This is an application of inverted file indexing applied to the gobbets as files. The index comprises an index of terms and, for each such term, an associated term list containing all of the gobbet IDs of gobbets that contained that term. The index of terms is organized in memory in such a way that a given term can be directly addressed; specifically, the corresponding term list (if any) can be retrieved in a constant amount of time irrespective of the size of the index. This is accomplished through the use of memory-mapped hash tables. Term lists are sequentially accessed but include a super-structure (a skip list), which allows skipping past blocks of gobbet IDs that fail to match user queries.

The processing to this point can be separated from the remaining steps as an independent process, in which any fixed set of queries can be pre-processed to create a gobbet index and gobbet repository for future use.

The fact query module 25 identifies (310) the terms that are contained in the user's query and then uses the gobbet index 27 to look up (311) the gobbet or gobbets that contain those terms; each gobbet so identified is referred to herein as a “fact”. The fact query module 25 then retrieves these gobbets from the gobbet repository 28 and collects them into a fact set (312), which is returned to the requesting client system 3 to be output to the user (313).

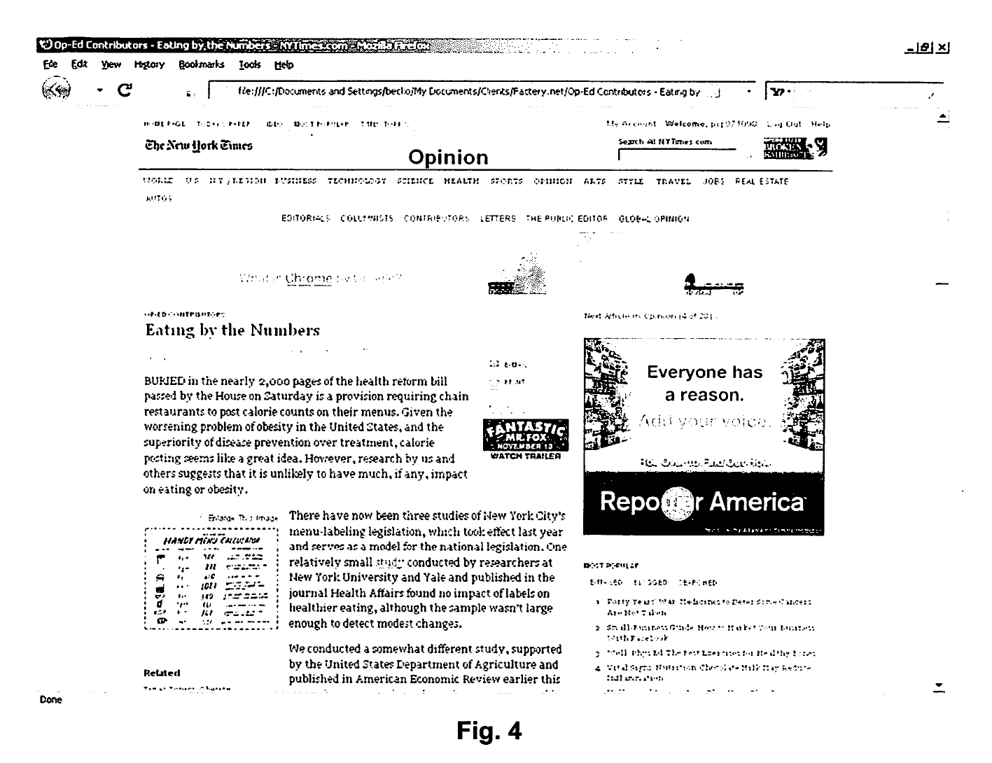

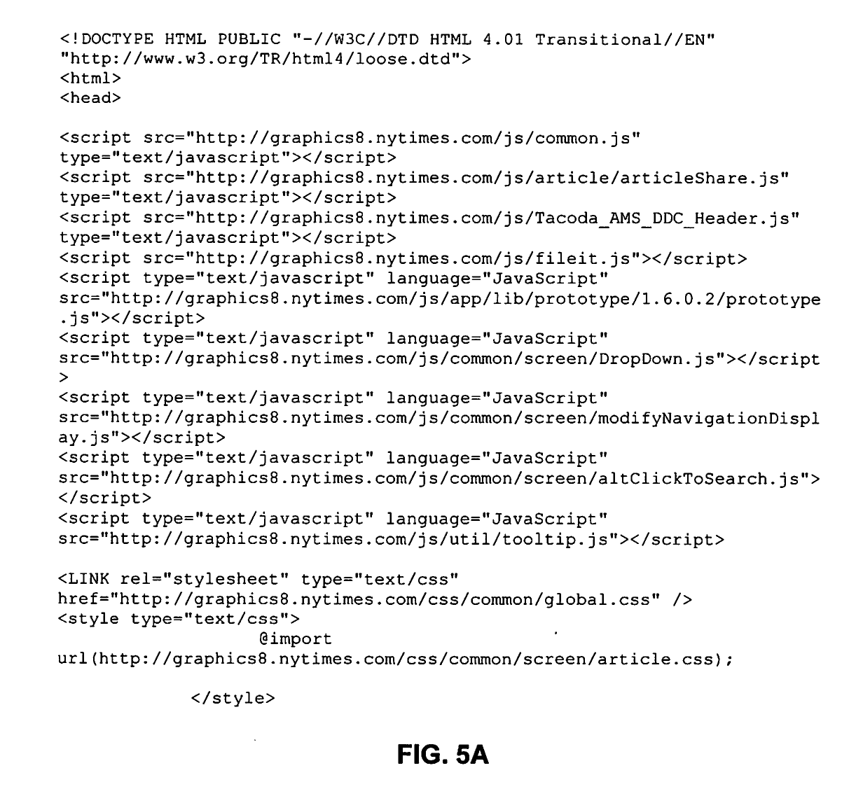

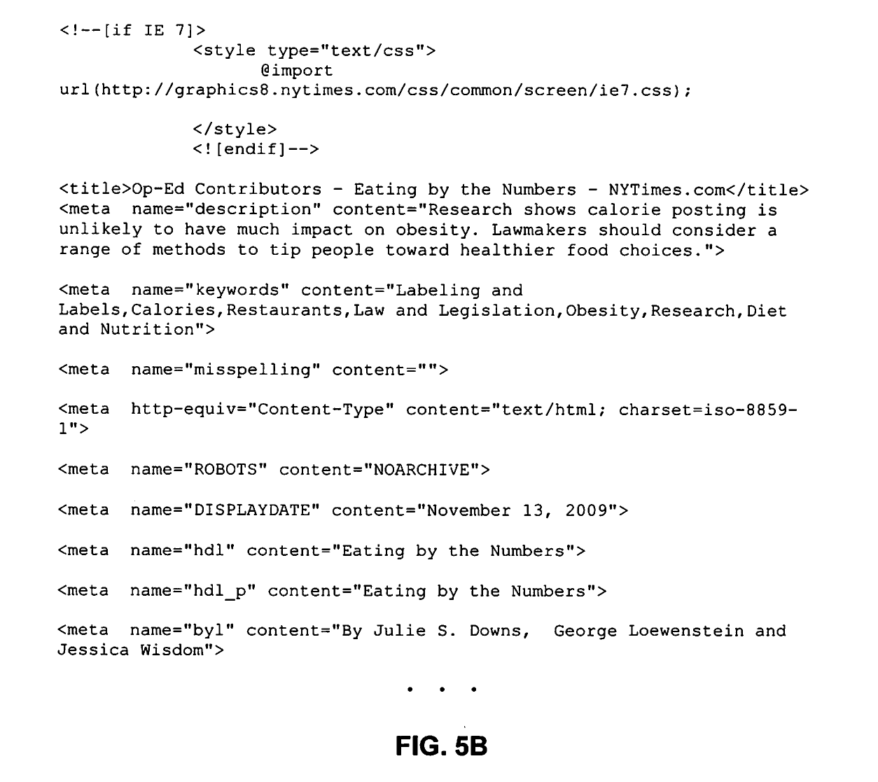

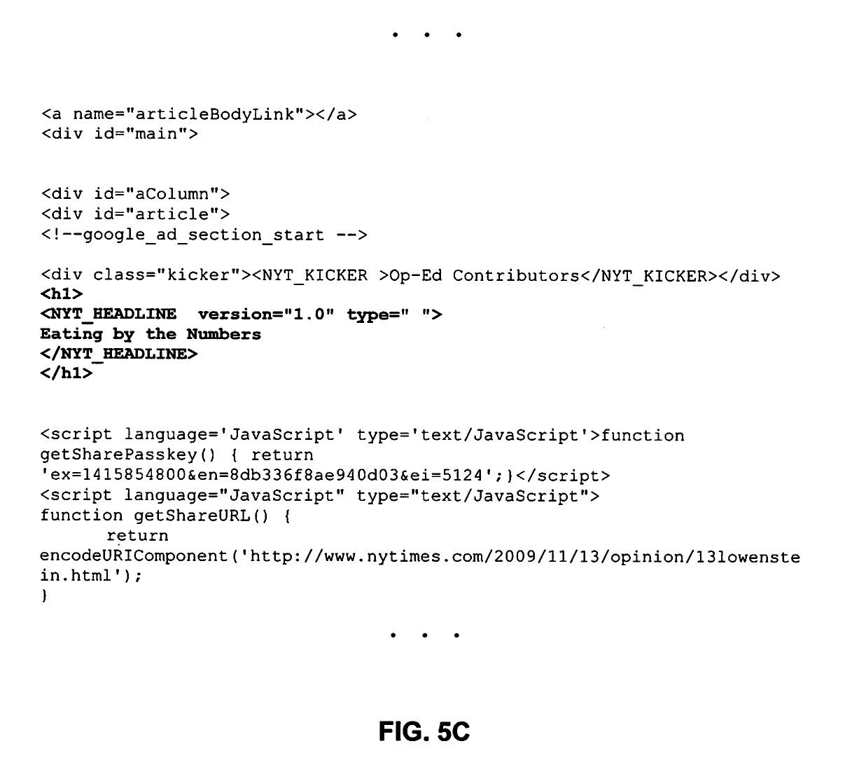

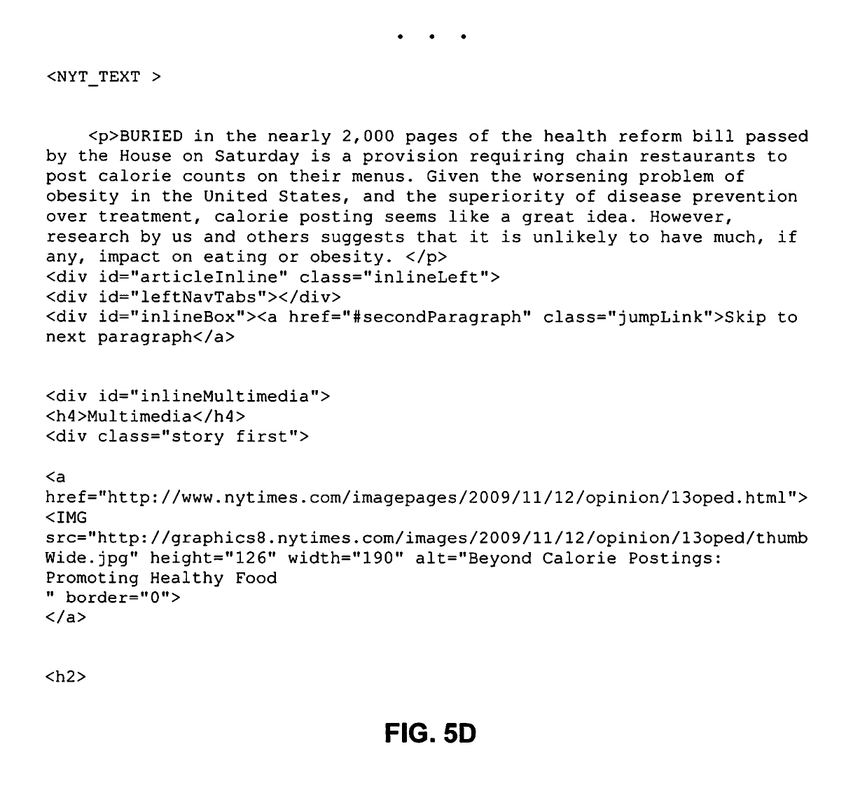

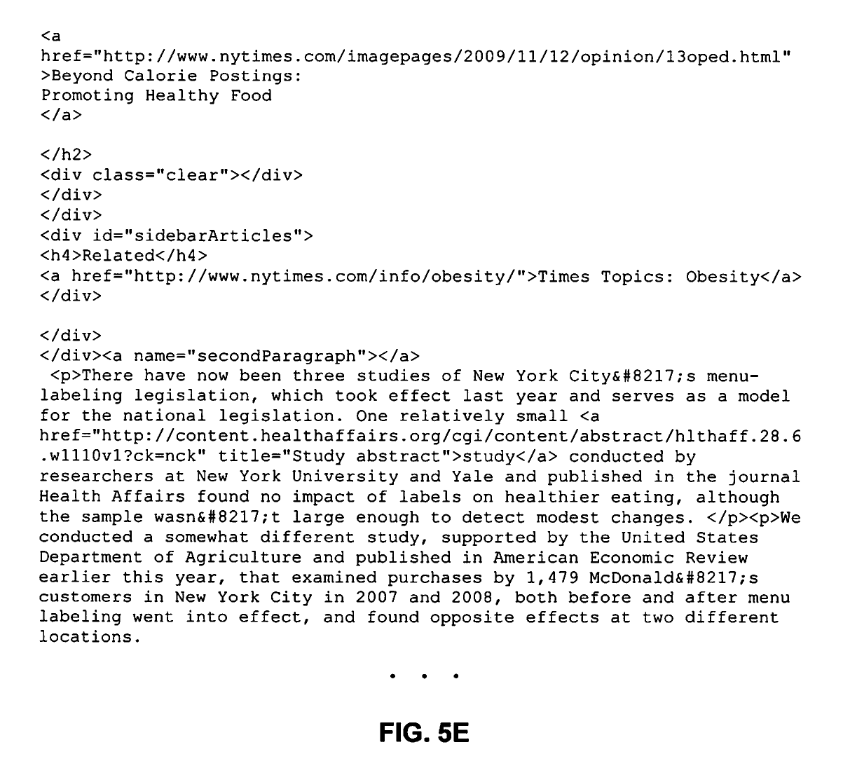

Operation of the search system 1 is further described now with reference to FIGS. 4 through 8. FIG. 4 shows an example of a portion of a web page that may be referenced by a URL that may be contained in the URL list received by the markup processor in response to the secondary query. FIGS. 5A through 5E show excerpts from the HTML source code associated with the portion of the web page shown in FIG. 4. Much of the source code shown in FIGS. 5A through 5E will be deleted by the normalization process; also, to avoid prolixity the source code has been edited so that FIGS. 5A through 5E omit (as indicated by ellipses) some of the code that would be deleted anyway by the normalization process. The effect of normalization can be seen, for example, by comparing the position of the heading “Eating by the Numbers” in FIG. 5C (identified by the tag “<h1>”) with its position in FIG. 6A, showing the normalized version. FIG. 6 illustrates an example of a portion of a normalized document corresponding to the source code illustrated in FIGS. 5A through 5E.

The normalized document has at least a body portion (denoted by the “<body>” tag), as can be seen from FIGS. 6, and may also have various metadata elements (denoted by a “<meta-item>” tag). The body portion contains the actual substantive content, i.e., the headings and sentences of the document. The normalization process retains all headings and the existing paragraph and sentence structure of the markup language document, but strips off other information deemed to be superfluous (e.g., graphics, advertising, etc). In one embodiment, each paragraph is set forth in its entirety in the normalized document, where each paragraph is immediately followed in the normalized document by each individual sentence that the paragraph contains. In one embodiment, the text processor uses a variation of the standard HTML paragraph tag, <p>, to denote the paragraph and sentence structure of the document. Specifically, it employs a paragraph continuation tag, <p cont=“x”>, where x is an integer greater than or equal to zero. The specific tag <p cont=“0”> denotes a complete paragraph as a whole. Where x is non-zero, the tag <p cont=“x”> denotes an individual sentence and the value of x indicates the position of the sentence within the paragraph that contains it (the paragraph denoted by the <p cont=“0”> tag). For example, <p cont=“1″> denotes the first sentence in a paragraph, <p cont=”2″> denotes the second sentence in the paragraph (if any), and so forth. Thus, the text processor generates, in the normalized document, a separate <p cont=“x”> item for each paragraph of text in the web page and also for each individual sentence in the web page.

The metadata elements in the normalized document can include, for example, the name of the author, the publication date of the document, and any information from the document that appears to be in the form of a key-value pair. In one embodiment the presence of a colon (“:”) is considered to be an indicator of a key-value pair. Another function of the normalization process is to keep track of and preserve the various section headings and their hierarchical relationships, if any, in the document.

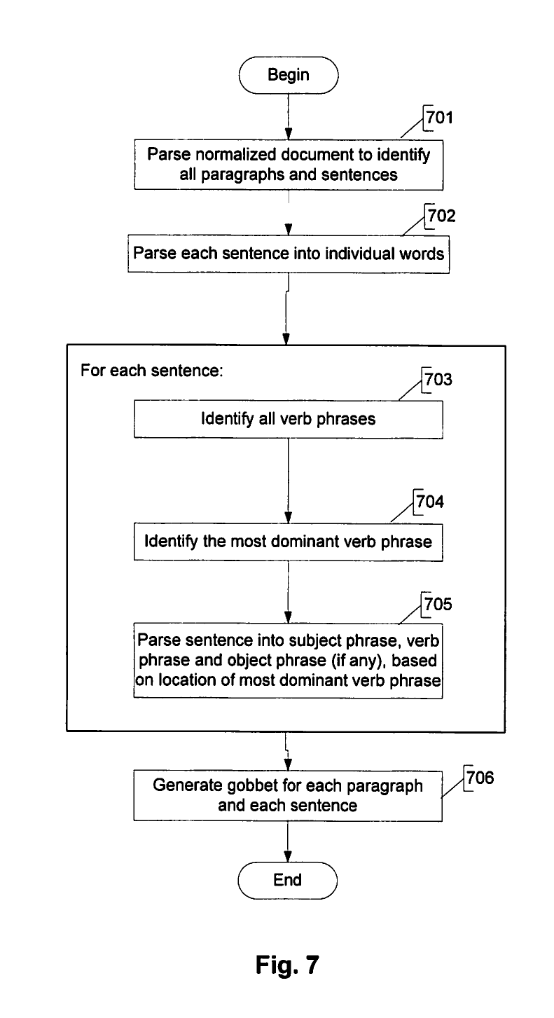

FIG. 7 illustrates in greater detail an example of the operation of the sentence processor 23, for a given normalized document as input. Initially, at 701 the sentence processor 23 parses the normalized document to identify all paragraphs and individual sentences in the normalized document and then parses each sentence into individual words at 702. Various techniques for parsing a document into sentences and words are well-known and need not be described herein.

Next, the sentence processor 23 performs operations 703, 704 and 705, for each sentence in the normalized document. At 703 the sentence processor 23 identifies all of the verb phrases in a given sentence. A verb phrase contains one or more words, including a single verb. To identify the verb phrases in the sentence, the sentence processor 23 tries to match one or more words in the sentence with contents of the verb phrase repository 26.

The verb phrase repository 26 is a text repository (e.g., a file or database) that preferably contains every conceivable form of every verb phrase in a given language (infinitive, gerund, all participles, etc.). For example, for the verb “to abide”, the verb phrase repository 26 would include at least the following entries:

abide

abided

were abiding

was abided

had been abiding

am abiding

are abiding

is abiding

have abided

have been abided

has been abided

would abide

is going to abide

will be abiding

am going to be abiding

are going to be abiding

would be abided

is going to be abided

will have abided

am going to have abided

are going to have abided

would have been abiding

is going to have been abiding

will have been abided

am going to have been abided

are going to have been abided

After identifying all of the verb phrases in the sentence, at 704 the sentence processor 23 identifies the dominant verb phrase in the sentence. The dominant verb phrase is the verb phrase that is deemed to be most important to the meaning of the sentence. If the sentence contains only one verb phrase, then that sentence is the most dominant verb phrase. On the other hand, consider for example the following sentence: “While walking to the store this morning, I ran into a good friend whom I hadn't seen in many years.” This sentence contains three separate verb phrases: 1) “while walking to the store this morning”, 2) “ran into a good friend” and 3) “hadn't seen in many years”. The second verb phrase, “ran into a good friend”, is the one that is most significant to the meaning of the sentence and is therefore the dominant verb phrase in the sentence; the other two verb phrases are ancillary, because they merely qualify the dominant verb phrase.

For example, in response to a user query, “Feynman Manhattan Project”, the system may find a document containing the following sentence:
Feynman began work on the Manhattan project at Princeton developing a theory of how to separate Uranium 235 from Uranium 238, while his thesis supervisor Wheeler went to Chicago to work with Fermi on the first nuclear reactor.

The sentence processor 23 decides which among the apparent verb phrases “began”, “developing”, “to separate”, “went to”, “to work with” is the dominant verb phrase. In this case the sentence processor 23 picks the verb “began”, with “developing” and “to separate” deemed as qualifying terms, and “went to”, and “to work with” appearing in a subordinate clause. The sentence processor 23 recognizes and records that this particular sentence occurs within the following paragraph:
Feynman began work on the Manhattan project at Princeton developing a theory of how to separate Uranium 235 from Uranium 238, while his thesis supervisor Wheeler went to Chicago to work with Fermi on the first nuclear reactor. Wigner, in Wheeler's absence, advised Feynman to write up his thesis and after Wheeler and aligner examined the work he received his doctorate in June 1942.

The sentence processor also recognizes and records that this particular sentence occurs within a context that includes a sequence of nested titles:

Feynman biography

Richard Phillips Feynman

The sentence processor 23 further recognizes and records that the enclosing document contains two relevant key-value pairs:

Born: 11 May 1918 in Far Rockaway, New York, USA

Died: 15 Feb. 1988 in Los Angeles, Calif., USA

When a sentence contains more than one verb phrase, the sentence processor 23 applies a set of criteria to identify the dominant verb phrase. For this purpose, the verbs in the verb phrase repository 26 are ranked in degree of dominance. In general, any form of the verb “to be” is considered more dominant than any other verb. After forms of “to be”, commonly used (“common”) verbs are considered more dominant than less commonly used (“uncommon”) verbs. Whether a verb is deemed “common” or “uncommon” can be based on an arbitrary threshold, such as the frequency of use of that verb in the corresponding language. Various statistics in this regard have been published. If two or more verb phrases in a sentence have the same degree of dominance, then the length of the verb phrases is used as a secondary criterion to determine the dominant one, with a longer verb phrase being considered dominant over a shorter verb phrases, as discussed further below. If two or more verb phrases in a sentence have equal degrees of dominance and length, the one that occurs earlier in the sentence is considered to be more dominant.

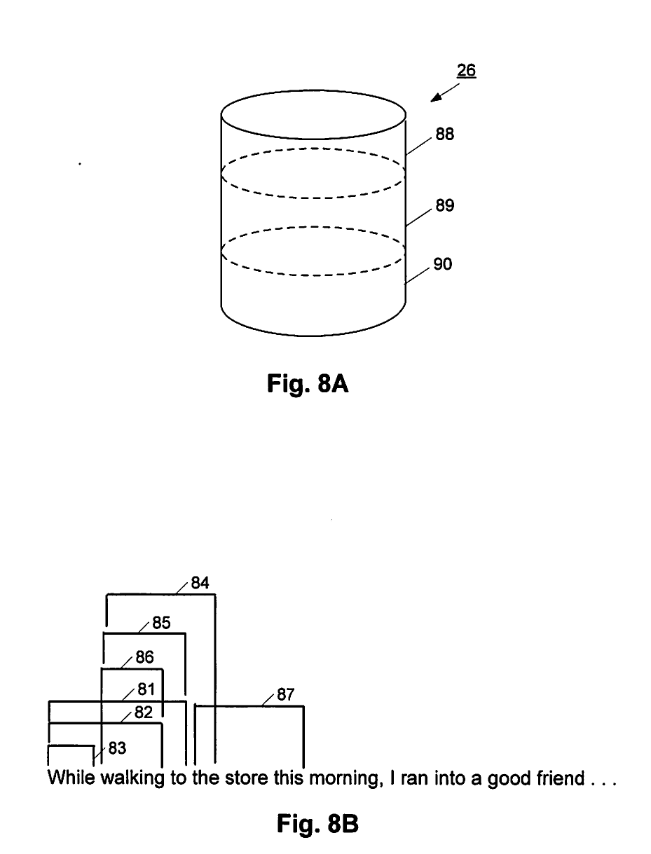

In one embodiment, to improve performance (speed), the verb phrase repository 26 is partitioned before run time into multiple tiers by degree of dominance (importance). For example, as shown in FIG. 8A, the verb phrase repository can be partitioned into the following three tiers, in descending order of dominance: 1) a top tier 88 containing all forms of only the verb “to be”, 2) a middle tier 89 containing common verbs (both regular and irregular), and 3) a bottom tier 90 containing uncommon verbs. Here the top tier 88 is the most dominant tier in the hierarchy while tier 90 is the least dominant tier. In such an embodiment, steps of identifying the verb phrases (703) and identifying the dominant verb phrase (704) can be combined. For example, the sentence processor 23 would first try to match a phrase in the sentence against content in the top tier 88; only if no match is found for that phrase in the top tier 88 would it then try to match the phrase against content in the middle tier 89, and so forth.

In one embodiment, the sentence processor 23 tries to match words in the sentence with contents of the verb phrase repository by comparing a sliding n-gram in the sentence (a set of n consecutive words in the sentence) to the verb phrase repository 26. FIG. 8B illustrates this approach for a given sentence. In one embodiment a fixed (but configurable) maximum word length, N, of the sliding n-gram is set prior to run time. For a given sentence, the system starts at the beginning of the sentence and attempts to match exactly the first n words of the sentence (in the order in which they appear in the sentence) with an entry in the verb phrase repository, where n is initially set to the maximum length, N, and then successively decremented if necessary until a match is found. When a match is detected, n is reset to the maximum length, N, and the n-gram is shifted forward in the sentence (to the right in English) just far enough so that it does not include any word that has already been considered in the sentence. If no match is found after examining the n-gram for all values of n=1, . . . N, then n is reset to N, and the entire n-gram is shifted one word forward in the sentence, and the process repeats.

In the example of FIG. 8B, the maximum value of n is N=3. So, for example, the sentence processor 23 initially attempts to find a match for n-gram 81 (“word1 word2 word3”) (n=3) with an entry in the verb phrase repository 26, then attempts to find a match for n-gram 82 (n=2), and then n-gram 83 (n=1). If no match is found for any of these n-grams, the sentence processor 23 then attempts to find a match for n-gram 84 (n=3), then n-gram 85 (n=2), then n-gram 86 (n=1); and so forth. When a match is detected, n is reset to N (3 in this example) and the n-gram is shifted forward in the sentence just far enough so that it does not include any word that has already been considered in the sentence. For example, if a match is detected for any of n-grams 81-83, the sentence processor 23 would then next consider n-gram 87.

Referring again to FIG. 7, after identifying the dominant verb phrase, at 705 the sentence processor 23 parses the sentence into at least a subject phrase and a verb phrase, and in some cases an object phrase (a phrase which is the direct object of the dominant verb phrase), based on the location of the dominant verb phrase in the sentence. In one embodiment, the subject phrase is taken to be the noun phrase (one or more words including a noun) that most closely precedes the dominant verb phrase in the sentence. A simple pattern recognizer can be used to identify nouns. For example, a noun can be identified as any word which immediately follows “a”, “an” or “the”, as well as names (e.g., capitalized words), etc. The object phrase is taken to be the verb phrase (if any) which most closely follows the dominant verb phrase. Finally, at 706 the sentence processor 23 generates a separate gobbet to represent each paragraph and each sentence in the normalized document.

Referring again to the illustrative web page in FIG. 4, the sentence processor 23 generates a separate gobbet for each paragraph of text in the web page and also for each of the individual sentences that make up those paragraphs. Stated another way, and referring to the normalized document shown by example in FIG. 6, the sentence processor 23 generates a separate gobbet for each chunk of text that is tagged with a <p cont=“x”> tag.

In one embodiment, a gobbet is a data object that includes both content items and context items. The content items can include, for example, the subject phrase of the corresponding sentence, the dominant verb phrase of the sentence, and the object phrase (if any) of the sentence. The context items are metadata which can include, for example: a gobbet identifier (ID) that uniquely identifies the gobbet within the search system; the URL of the markup language document from which the sentence was extracted; one or more implied subjects of the sentence (e.g., any heading, or any one of the chain of headings, that enclose the paragraph in which the sentence resides); a timestamp indicating when the source document was fetched; a parent gobbet ID indicating which gobbet, if any, is the parent of this gobbet (e.g., for a sentence gobbet, the parent gobbet is the gobbet representing paragraph which includes that sentence); and a quality indicator (may indicate the degree of relevance of the gobbet to a particular query, and may be assigned by the fact query module after the gobbet has been indexed; and an application-opaque ID (i.e., opaque to the search system). Each gobbet is stored in the gobbet repository, indexed by its gobbet ID.

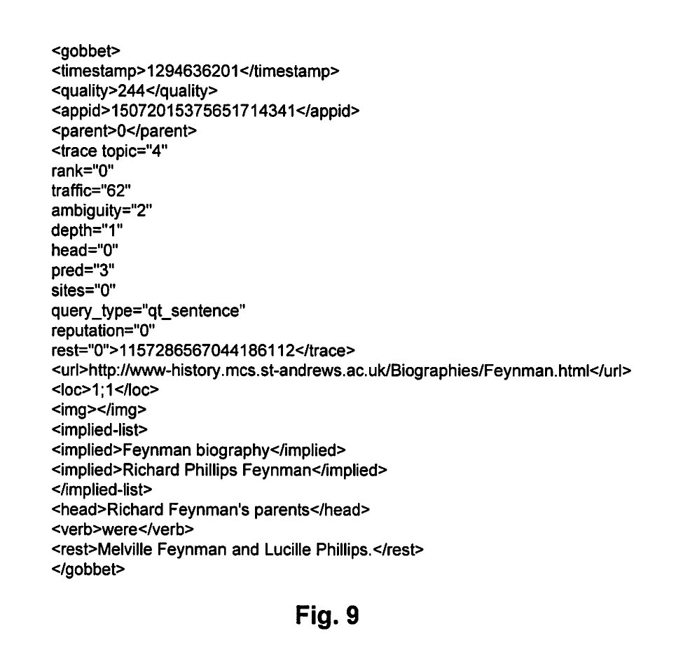

FIG. 9 illustrates an example of a gobbet. The illustrated gobbet includes:

```
Timestamp = 1294636201
Quality = 244
Appid = 15072015375651714341
Parent = 0
Trace = 1157286567044186112
    topic=“4”
    rank=“0”
    traffic=“62”
    ambiguity=“2”
    depth=“1”
    head=“0”
    pred=“3”
    sites=“0”
    query_type=“qt_head_exact_phrase”
    reputation=“0”
    rest=“0”
  url =http://www-
history.mcs.standrews.ac.uk/Biographies/Feynman.html
  loc = 1;1
  img =
  implied-list =
    Feynman biography
    Richard Phillips Feynman
  Head = Richard Feynman 's parents
  Verb = were
  Rest = Melville Feynman and Lucille Phillip
```

In the above example:

1. ‘Timestamp’ is recorded as a Unix timestamp, namely, as seconds elapsed since midnight Coordinated Universal Time (UTC) of Jan. 1, 1970, not counting leap-seconds.

2. ‘Quality’ is recoded on an arbitrary (but consistent) scale with 0 being the highest quality and larger numeric values indicating lesser quality.

3. ‘Appid’ is an opaque, application-dependent identifier that can be used flexibly to record a small amount (e.g., 64 bits) of arbitrary information about any given gobbet.

4. ‘Parent’ is the gobbet ID in the current gobbet repository of the enclosing gobbet (if any) of the given gobbet.

5. ‘Trace’ is a packed number (e.g., 64 bits) encoding information related to the quality of the gobbet, as explained in more detail below.

6. ‘url’ is a enclosing document Uniform Resource Locator.

7. ‘loc’ is the position of the sentence/paragraph/image/video/key-value pair within the normalized document, represented as a pair (paragraph number; sentence number).

8. ‘img’ is the URL (Uniform Resource Locator) of any image associated to the gobbet.

9. ‘implied-list’ is the list of enclosing titles.

10. ‘Head’ is the sentence subject.

11. ‘Verb’ is the dominant verb phrase.

12. ‘Rest’ is the sentence predicate.

The ‘Trace’ is, in one embodiment, a packed 64-bit structure that includes the following items:

1. ‘topic’ (bits 58 . . . 63)—a penalty score assessed for weak resemblance to the topic sentence of the enclosing paragraph.

2. ‘rank’ (bits 53 . . . 57)—a penalty score assessed for low page rank of the enclosing document.

3. ‘traffic’ (bits 46 . . . 51)—a penalty score assessed for low web traffic to the enclosing document.

4. ‘ambiguity’ (bits 40 . . . 45)—a penalty score assessed for high levels of verb ambiguity in the sentence.

5. ‘depth’ (bits 30 . . . 33)—a penalty score assessed depending on how deep into an enclosing paragraph the sentence (from which the gobbet is derived) appears.

6. ‘head’ (bits 28 . . . 29)—a penalty score assessed for sentences with very short subject phrases.

7. ‘pred’ (bits 26 . . . 27)—a penalty score assessed for sentences with very short predicate phrases.

8. ‘site’ (bits 22 . . . 25)—a boost score assessed for certain (authoritative) sites, for example nytimes.com, wikipedia.org.

9. ‘query_type’ (bits 16 . . . 21)—records the type of query that returned this gobbet. ‘query_type’ can have the following values, which are explained in detail below:
qt_head_exact_phrase
qt_head_phrase
qt_head
qt_url
qt_phrase
qt_weak_phrase
qt_implied
qt_mixed_and
qt_mixed_implied_and
qt_and
qt_or
qt_widget
qt_tophit
qt_video
qt_image
qt_keyval

10. ‘reputation’ (bits 10 . . . 15)—records the authority of the original source (URL) author (individual or organization).

11. ‘rest’ (bits 0 . . . 9)—labels the remaining unallocated bits of the trace structure.

As noted above, after generating a gobbet set (FIG. 3, 307), the GSI module 24 generates a term set for each gobbet set (308), and then indexes all of the terms and stores all of the gobbets. Each term set includes one or more terms, where a “term” is a k-gram of words from the set of normalized documents generated from a given search query. In one embodiment, a term set is defined to include every k-gram from the sentences in the corresponding gobbet set, where k=1, . . . M, and where in one embodiment M=3. The terms (k-grams) are then indexed in the gobbet index.

To index the terms, in one embodiment each term is applied to a hash function to generate a hash value, which is used as an index value into the gobbet index. Each entry in the gobbet index represents one term and includes the hash value of that term and the gobbet ID of each gobbet that includes that term. The hash value is used as an index to locate that entry later.

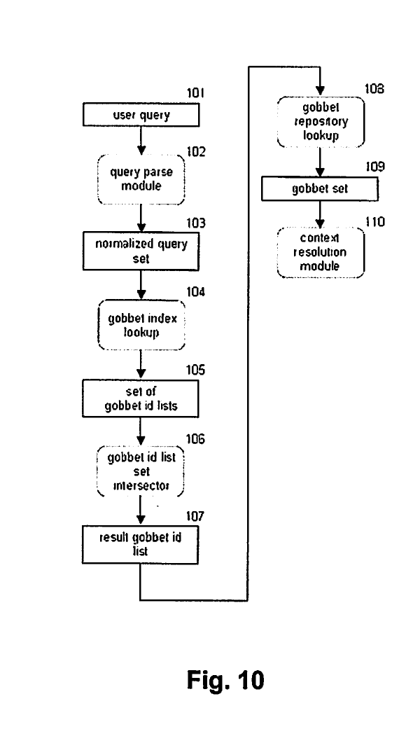

After the terms are indexed and the gobbets are stored, the fact query module 25 queries the gobbet index 27 with the user query to retrieve a term set (FIG. 3, 310). In one embodiment, this is accomplished as illustrated in FIG. 10.

Referring to FIG. 10, the user query 101 includes of a list of words. The query parse module 102 scans the user query and matches a series of patterns to determine if the query has the form of a question. The query parse module 102 converts interrogative queries into declarative forms and outputs a normalize query set 103. For example, the query “what is the highest city in the world”, will be converted into “the highest city in the world”. The query parse module 102 also determines if the query matches patterns corresponding to the following categories:

a. Products

b. Ticker symbols

c. Music-related

d. Current news

e. Geographic

f. Weather

g. Subject-Verb phrase

The query parse module 102 determines if the user query consists of a combination of these categories, for example, geographically localized product queries, (e.g.) “best pizza in Palo Alto”, will be parsed into three segments: “best”, “pizza” (a product), “Palo Alto” (a location). The query parse module 102 operates by matching a sequence of regular expressions against the user query. If a given regular expression matches, for example, a product pattern, then the query parse module 102 removes the portion of the query that matches this pattern, and continues to match against the remainder of the query. The query parse module 102 continues in this manner, removing matching segments, until either the query is exhausted or the set of patterns is exhausted. Each extracted segment of the query is labeled by the category that it matched. The unmatched remainder of the query (which may be the entire query) is also returned.

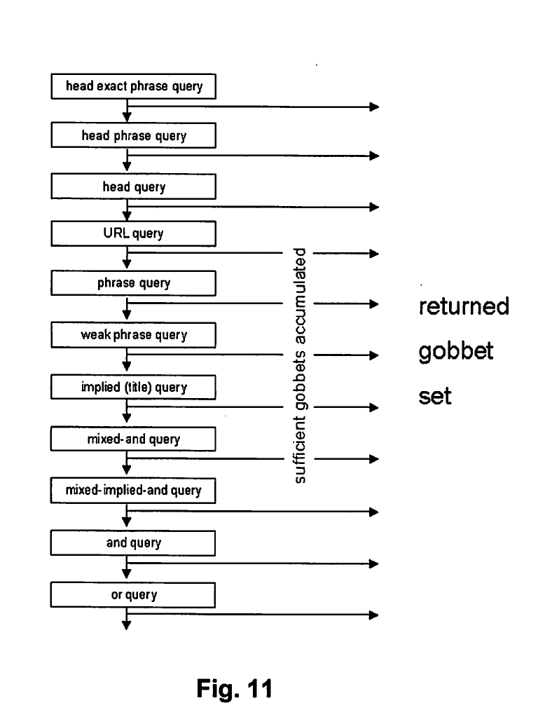

The query parse module 102 generates a query plan. The query plan includes of a list of very specific queries derived from the original user query. The plan queries define subsets of the gobbet repository that match gobbet-specific conditions. FIG. 11 shows the query evaluation process for the set of plan queries corresponding to an input user query. For example, the user query “highest city in the world” generates the following query plan:

head-phrase:highest_city_in_the_world (1)

head:highest_city_in_the_world (2)

head:highest+head:city+head:in+head:the+head:world (3)

url:highest+url:city+url:world (4)

highest_city+city_in+in_the+the_world (5)

highest_city+in_the+world (6)

implied:highest+implied:city+implied:in+implied:the+implied:world (7)

head:highest+city+in+the+world (8)

implied:highest+city+in+the+world (9)

highest+city+in+the+world (10)

highest|city|world (11)

Plan query (1), the head-exact-phrase-query, defines a query that matches the user query completely and exactly within the subject portion of one gobbet. Plan query (2), the head-phrase-query, defines a query that matches the user query phrase anywhere within the subject portion of one gobbet. Plan query (3), the head-query, defines a query that matches each term of the user query independently within the subject portion of one gobbet. Plan query (4), the URL-query, defines a query that matches the non-stop-word terms of the user query within the path portion of the enclosing document URL of one gobbet. Stop words are very common worlds, typically articles and conjunctions, which do not add specificity to the query. In the example of “highest city in the world” —“in”, and “the” are stop words, and can be removed from the query when matching against the document URL. Plan query (5), the phrase-query, defines a query that matches overlapping bi-grams formed from the user query anywhere in one gobbet. Plan query (6), the weak-phrase-query, defines a query that matches non-overlapping bi-grams anywhere in one gobbet. Plan query (7), the implied-(title)-query, defines a query that matches each of the user query terms anywhere within the title-list of one gobbet. Plan query (8), the mixed-and-query, defines a query that matches the leading term of the user query within the subject portion of one gobbet, and the remaining terms of the user query anywhere within that gobbet. Plan query (9), the mixed-implied-and-query, defines a query that matches the leading term of the user query within the title-list portion of one gobbet, and the remaining terms of the user query anywhere within that gobbet. Plan query (10), the and-query, defines a query that matches each of the user query terms anywhere within one gobbet. Plan query (11), the or-query, defines a query that matches any one of the non-stop-word terms of the user query anywhere within one gobbet.

All plan queries, with the exception of (11), the or-query, include conjunctions. That is to say the plus sign “+” in the query is taken to mean “AND”. The constituents of each plan query are called elementary plan queries. For example, “url:highest” is an elementary plan query. It defines a subset consisting of all the gobbets containing the term “highest” anywhere within the path portion of the URL.

Referring again to FIG. 10, the gobbet index lookup module 104 operates by converting each elementary plan query (string) into a single hash value H, and then looking up this hash value within a memory-mapped hash index. The hash index contains pointer references to memory-mapped gobbet id lists 105. The gobbet ID lists 105 contain ordered lists of 64-bit unsigned integer IDs of the gobbets previously found to match the query pattern with hash value H.

The gobbet id list set intersector 106 processes a collection of input gobbet ID lists 105 and outputs the list of gobbet ids common to all the input ID lists. Considering each input gobbet ID list as defining subset of gobbets (with the corresponding IDs), then the gobbet id list set intersector 106 exactly returns the result gobbet ID list 107 representing the intersection of this collection of input sets. The gobbet id list set intersector 106 performs a multi-way merge operation on the gobbet ID list, which are ordered, compressed lists of unsigned integer values.

The gobbet ID lists in some embodiments may contain skip lists that allow accelerated comparisons between pairs of gobbet ID lists. A skip list comprises a set of pointers mixed into the gobbet ID lists at regular or random intervals that define a jump value and a jump location. For example, the simple gobbet ID list:

(1, 3, 5, 10, 15, 30, 200, 201, 211, 250, 251, 252, 305, 500, 510) (A)

can be improved by adding the following skip list entries:

([200:5], 1, 3, 5, 10, 15, 200, [300:6], 201, 211, 250, 251, 252, 305, 500, 510)

Skip list entries make it possible to accelerate the comparison between two gobbet ID lists when looking for common entries. For example, if a second gobbet ID list

(201, 202, 203, 250, 260, 270, 301, 302, 303, 304, 305) (B)

were compared to list (A), the skip entry [200:5] records the information that the first gobbet ID equal or greater than 200 occurs five steps past the first entry, and allows the comparison processor to skip the first six entries (including the skip entry itself) of list (A) when comparing it to list (B).

The gobbet id list set intersector 106 is applied at each stage of the query plan evaluation to compute the gobbet ID list corresponding to the conjunctive condition defined by that stage of the query plan. For example, plan query (4), “url:highest+url:city+url:world” requires intersecting three gobbet ID lists corresponding to the three terms “url:highest”, which returns a gobbet ID list comprising all the gobbets in the gobbet repository containing “highest” anywhere in the path portion of the URL, “url:city”, which returns a gobbet id list comprising all the gobbets in the gobbet repository containing “city” anywhere in the path portion of the URL, and “url:world”, which returns a gobbet ID list comprising all the gobbets in the gobbet repository containing “world” anywhere in the path portion of the URL. The output of this stage of the query plan processing is the gobbet ID list including all the gobbets in the gobbet repository that contain all three terms anywhere in the path portion of the URL.

The query plan process (FIG. 11) continues evaluating stages in the order shown, until either it has accumulated a sufficient number of gobbets, or there are no more stages. What constitutes a “sufficient” number of gobbets is application-dependent and can be varied at will.

The gobbet repository lookup module 108 processes an input gobbet ID list 107 and outputs a set of gobbets 109 corresponding to the input IDs. The gobbet repository lookup module 108 maintains a two-level structure including: (1) a directly indexed fixed-width memory-mapped vector of gobbet-representatives, and (2) a memory-mapped heap of variable-width strings associated to each gobbet. The gobbet-representative consists of a number of fixed-width fields corresponding one-to-one with the fields of a gobbet, but with the difference that the variable-width gobbet fields, namely the URL, location, image, title list, subject, verb, and predicate are all represented in the gobbet-representative as fixed-width offsets into the secondary memory-mapped heap of strings. Heap offsets are used to fetch a fixed maximum sized chunk of the heap. Strings within the heap are zero-delimited. The actual length of a string retrieved from the heap can be determined by scanning the maximum-length chunk for the first occurrence of a null (0) character. This null (0) character conventionally defines the end of the string.

The context resolution module 110 processes an input set of gobbets 109 and outputs an ordered subset of those gobbets and the final form of the fact query response to the original user query 101. The context resolution module 110 applies one or more regular expression and/or Bloom filter pattern-matching steps to eliminate non-English, non-relevant, and offensive gobbets from the input set. It also looks for cases of multiple input gobbets from the same paragraph of the same document. In the case when three or more gobbets occur closely within the same enclosing paragraph, then the context resolution module 110 will replace the subset of all gobbets pertaining to the enclosing paragraph with a single gobbet representing the entire paragraph.

FIG. 11 illustrates an example of the process of generating a fact set from the resulting term set. The system forms a list of related queries based on the original user query, comprising a “query plan”. This query plan includes the following queries corresponding to the various “query-types” recorded in the gobbet trace:

a. qt_head_exact_phrase
The entire query matched exactly the entire sentence subject.

b. qt_head_phrase
The entire query matched within the sentence subject.

c. qt_head
Part of the query matched within the sentence subject.

d. qt_url
Part of the query matched part of enclosing document URL.

e. qt_phrase
The entire query matched as a phrase anywhere in the sentence.

f. qt_weak_phrase
The entire query matched weakly as a phrase. Weak phrasing is defined as the conjunction of consecutive bi-grams. The phrase “Richard Feynman's parents” has a weak phrase match if both the bigrams “Richard Feynman's” and ‘Feynman's parent” appear in the sentence.

g. qt_implied
Part of the query matched within the enclosing titles of the sentence.

h. qt_mixed_and
the first term of the query matched in the sentence subject and the remaining terms matched anywhere in the sentence

i. qt_mixed_implied_and
the first term of the query matched within the enclosing titles of the sentence, and the remaining terms matched anywhere within the document.

j. qt_and
Each of the terms of the query matched somewhere within the sentence, but not necessarily as a phrase.

k. qt_or
Any of the terms of the query matched anywhere within the sentence.

l. qt_widget
The query returned a result from an external gobbet source (or widget)—for example a weather widget that returns current weather information in gobbet format. Other examples include stock price widgets, product price widgets, and merchant services widgets.

m. qt_tophit
The gobbet represents a URL that is regarded as the best reference related to a given query.

n. qt_video
The gobbet represents a video extracted from a web resource relevant to the query.

o. qt_image
The gobbet represents an image extracted from a web resource relevant to the query.

p. qt_keyval
The gobbet represents a key-value pair extracted from a web resource relevant to the query.

The fact query module 25 evaluates these queries in priority order (a) . . . (p) either sequentially or concurrently, and stops when it has found a sufficient number of useful gobbets. The number of gobbets considered “sufficient” can be determined empirically and can be set to any finite value

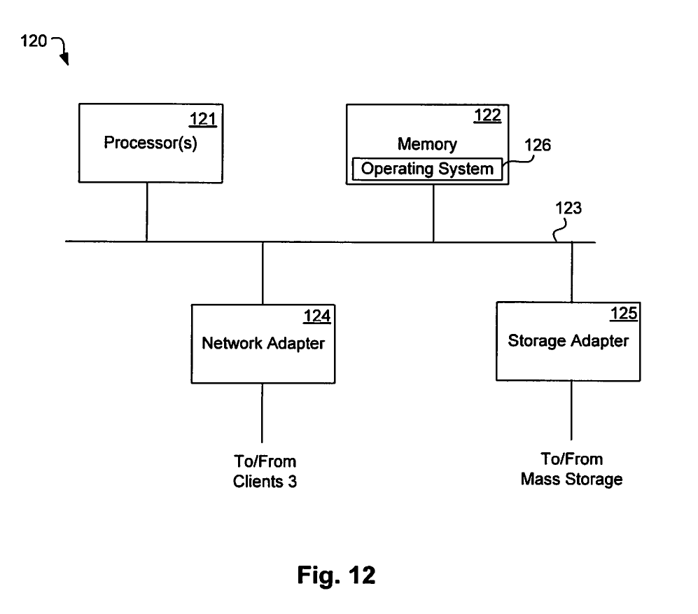

FIG. 12 illustrates an example of the architecture of a processing system that can embody the search system and/or a client system. In the illustrated embodiment, the processing system 120 includes one or more processors 121 and memory 122 coupled to an interconnect 123. The interconnect 123 is an abstraction that represents any one or more separate physical buses, point-to-point connections, or both, connected by appropriate bridges, adapters, or controllers. The interconnect 123, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The processor(s) 121 is/are the central processing unit (CPU) of the processing system 120 and, thus, control the overall operation of the processing system 120. In certain embodiments, a processor(s) 121 accomplishes this by executing software or firmware stored in memory 122. In other embodiments, a processor 121 can be special-purpose, hardwired (non-programmable) circuitry. Thus, a processor 121 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 122 is or includes the main memory of the processing system 120. The memory 122 represents any form of random access memory (RAM), read-only memory (ROM), flash memory, or the like, or a combination of such devices. In use, the memory 92 may contain, among other things, code 126 for executing some or all of the operations described above.

Also connected to the processor(s) 121 through the interconnect 123 are a network adapter 124 and a storage adapter 125. The network adapter 124 provides the processing system 120 with the ability to communicate with remote devices, such as a client system 3, over the network 2 and may be, for example, an Ethernet adapter or Fibre Channel adapter. The storage adapter 125 allows the processing system 120 to access a mass storage subsystem (not shown) and may be, for example, a Fibre Channel adapter or SCSI adapter. The mass storage subsystem four can be used to store, among other things, the verb phrase repository 26, the gobbet index 27 and the gobbet repository 28.

The techniques introduced above can be implemented by programmable circuitry programmed/configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

Software or firmware to implement the techniques introduced here may be stored on a machine-readable storage medium and may be executed by one or more general-purpose or special-purpose programmable microprocessors.

A “machine-readable medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible medium includes recordable/non-recordable media (e.g., read-only memory (ROM); random access memory (RAM); magnetic disk storage media; optical storage media; flash memory devices; etc.), etc.

References in this specification to “an embodiment”, “one embodiment”, or the like, mean that the particular feature, structure or characteristic being described is included in at least one embodiment of the present invention. Occurrences of such phrases in this specification do not necessarily all refer to the same embodiment. On the other hand, different embodiments may not be mutually exclusive either.

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense.

What is claimed is:

1. A method comprising:
receiving, at a computer system, a search query provided by a user; and
in the computer system, responsive to the search query,
identifying a set of network locators relevant to the search query, including at least one network locator, each said network locator corresponding to a separate information resource stored on a network;
retrieving a set of information resources, including at least one information resource, corresponding to the set of network locators,
processing the set of information resources to extract an information item from the set of information resources, and
returning the information item as a response to the search query.

2. A method as recited in claim 1, wherein each of the network locators comprises a uniform resource locator (URL).

3. A method as recited in claim 1, wherein processing the set of information resources to extract an information item from the set of information resources comprises:
producing a normalized document for each information resource in the retrieved set of information resources;
producing a gobbet set, including at least one gobbet from each said normalized document;
selecting at least one gobbet from the gobbet set; and
creating said information item for output to the user, from the selected at least one gobbet.

4. A method as recited in claim 1, wherein producing a gobbet set comprises:
producing a separate gobbet to represent each sentence in each said normalized document.

5. A method as recited in claim 4, wherein producing a separate gobbet to represent each sentence in each said normalized document comprises:
identifying a dominant verb phrase in each sentence of each said normalized document; and
identifying a subject of each sentence of each said normalized document.

6. A method as recited in claim 5, wherein identifying a dominant verb phrase comprises:
using a rolling n-gram window to detect a match between part of a sentence in a normalized document and content in a database of known verb phrases, where n is greater than one.

7. A method as recited in claim 6, wherein the database of known verb phrases comprises a multi-tiered hierarchy of verb phrases, including a plurality of tiers organized by preference, each tier having a different preference weight for determining a match with part of a sentence in a normalized document.

8. A method as recited in claim 7, wherein the plurality of tiers comprise:
a first tier including only “to be” verb phrases, the first tier having the highest weight of the plurality of tiers.

9. A method as recited in claim 8, wherein using a rolling n-gram window comprises:
preferring a match of a first verb phrase for which n equals M over a match of second verb phrase for which n is less than M, to identify a match between part of a sentence in a normalized document and content in the database of known verb phrases.

10. A method as recited in claim 4, wherein each gobbet is a data object comprising:
a gobbet identifier;
a network locator corresponding to a source of the gobbet; and
a plurality of content items including a subject phrase and a verb phrase.

11. A method as recited in claim 4, wherein processing the set of information resources to extract an information item from the set of information resources further comprises:
storing and indexing, in a gobbet repository, each gobbet in the gobbet set.

12. A method as recited in claim 11, wherein indexing each gobbet in the gobbet set comprises:
generating a separate index term for each word of an identified subject phrase and an identified verb phrase in each sentence of a set of sentences identified in each said normalized document;
generating an encoded value to represent each said index term; and
storing in the gobbet repository each said index term indexed by its encoded value.

13. A method as recited in claim 11, wherein selecting at least one gobbet comprises selecting the at least one gobbet from the gobbet repository.

14. A network search system comprising:
a first processor configured to receive a search query provided by a requester, to invoke a third-party search API based on the search query, and to receive a set of network locators relevant to the search query as a result of invoking the third-party search API, the set of network locators including at least one network locator and each corresponding to a separate information resource stored on a network, the first processor further configured to retrieve a set of information resources including at least one information resource for each network locator in the received set of network locators in response to the search query, and to produce a document from each said information resource;
a second processor to produce from each said document a normalized document;
a third processor to produce a first gobbet set, including at least one gobbet, from each said normalized document, by producing a separate gobbet to represent each sentence in each said normalized document;
a gobbet store and index module to store and index, in a gobbet repository, each gobbet in the first gobbet set; and
a query system to select a second gobbet set, including at least one gobbet, from the gobbet repository in response to the search query, and to return the second gobbet set to the requester as a response to the search query.

15. A network search system as recited in claim 14, wherein each of the network locators comprises a uniform resource locator (URL).

16. A network search system as recited in claim 14, wherein producing a separate gobbet to represent each sentence in each said normalized document comprises:
identifying a dominant verb phrase in each sentence of each said normalized document; and
identifying a subject of each sentence of each said normalized document.

17. A network search system as recited in claim 16, wherein identifying a dominant verb phrase comprises:
using a rolling n-gram window to detect a match between part of a sentence in a normalized document and content in a database of known verb phrases, where n is greater than one.

18. A network search system as recited in claim 17, wherein the database of known verb phrases comprises a multi-tiered hierarchy of verb phrases, including a plurality of tiers organized by preference, each tier having a different preference weight for determining a match with part of a sentence in a normalized document.

19. A network search system as recited in claim 18, wherein the plurality of tiers comprise:
a first tier including only “to be” verb phrases, the first tier having the highest weight of the plurality of tiers.

20. A network search system as recited in claim 19, wherein using a rolling n-gram window comprises:
preferring a match of a first verb phrase for which n equals M over a match of second verb phrase for which n is less than M, to identify a match between part of a sentence in a normalized document and content in the database of known verb phrases.

21. A network search system as recited in claim 14, wherein each gobbet is a data object comprising:
a gobbet identifier;
a network locator corresponding to a source of the gobbet; and
a plurality of content items including a subject phrase and a verb phrase.

22. A network search system as recited in claim 14, wherein indexing each gobbet in the first gobbet set comprises:
generating a separate index term for each word of an identified subject phrase and an identified verb phrase in each sentence of a set of sentences identified in each said normalized document;
generating an encoded value to represent each said index term; and
storing in the gobbet repository each said index term indexed by its encoded value.

23. A server system comprising:
a network adapter through which the server system can communicate over a network with a client;
a processor coupled to the network adapter; and
a memory coupled to the processor and storing code which, when executed by the processor, causes the server system to perform operations including:
receiving a search query provided by a user of the client; and
responsive to the search query,
identifying a set of network locators relevant to the search query, including at least one network locator, each said network locator corresponding to a separate information resource stored on the network;
retrieving a set of information resources, including at least one information resource, corresponding to the set of network locators,
processing the set of information resources to extract an information item from the set of information resources, and
providing the information item for output to the user as a response to the search query.

24. A server system as recited in claim 23, wherein each of the network locators comprises a uniform resource locator (URL).

25. A server system as recited in claim 23, wherein processing the set of information resources to extract an information item from the set of information resources comprises:
producing a normalized document for each information resource in the retrieved set of information resources;
producing a gobbet set, including at least one gobbet from each said normalized document;
selecting at least one gobbet from the gobbet set; and
creating said information item for output to the user, from the selected at least one gobbet.

26. A server system as recited in claim 23, wherein producing a gobbet set comprises:
producing a separate gobbet to represent each sentence in each said normalized document.

27. A server system as recited in claim 26, wherein producing a separate gobbet to represent each sentence in each said normalized document comprises:
identifying a dominant verb phrase in each sentence of each said normalized document; and
identifying a subject of each sentence of each said normalized document.

28. A server system as recited in claim 27, wherein identifying a dominant verb phrase comprises:
using a rolling n-gram window to detect a match between part of a sentence in a normalized document and content in a database of known verb phrases, where n is greater than one.

29. A server system as recited in claim 28, wherein the database of known verb phrases comprises a multi-tiered hierarchy of verb phrases, including a plurality of tiers organized by preference, each tier having a different preference weight for determining a match with part of a sentence in a normalized document.

30. A server system as recited in claim 29, wherein the plurality of tiers comprise:
a first tier including only “to be” verb phrases, the first tier having the highest weight of the plurality of tiers.

31. A server system as recited in claim 30, wherein using a rolling n-gram window comprises:
preferring a match of a first verb phrase for which n equals M over a match of second verb phrase for which n is less than M, to identify a match between part of a sentence in a normalized document and content in the database of known verb phrases.

32. A server system as recited in claim 26, wherein each gobbet is a data object comprising:
a gobbet identifier;
a network locator corresponding to a source of the gobbet; and
a plurality of content items including a subject phrase and a verb phrase.

33. A server system as recited in claim 26, wherein processing the set of information resources to extract an information item from the set of information resources further comprises:
storing and indexing, in a gobbet repository, each gobbet in the gobbet set.

34. A server system as recited in claim 33, wherein indexing each gobbet in the gobbet set comprises:
generating a separate index term for each word of an identified subject phrase and an identified verb phrase in each sentence of a set of sentences identified in each said normalized document;
generating an encoded value to represent each said index term; and
storing in the gobbet repository each said index term indexed by its encoded value.

35. A server system as recited in claim 33, wherein selecting at least one gobbet comprises selecting the at least one gobbet from the gobbet repository.
